(19) United States
(12) Patent Application Publication
(10) Pub. No.: US 2021/0075051 A1
(43) Pub. Date: Mar. 11, 2021

(54) BUTTON BATTERY FOR IMPROVING UTILIZATION RATE OF RADIAL SPACE

(71) Applicant: CHONGQING VDL ELECTRONICS CO., LTD., CHONGQING (CN)

(72) Inventor: Xianmao Zhou, Chongqing (CN)

(21) Appl. No.: 17/009,805

(22) Filed: Sep. 2, 2020

(30) Foreign Application Priority Data
Sep. 5, 2019 (CN) 201910835204.X

(51) Int. Cl. H01M 10/04; H01M 2/08; H01M 2/04; H01M 2/02

(52) U.S. Cl. CPC H01M 10/0427; H01M 2/0222; H01M 2/0426; H01M 2/08

(57) ABSTRACT

The present disclosure includes a metal housing, a cell arranged in the metal housing, and a cover plate arranged on the metal housing. The cell includes a cathode and an anode. The cover plate and the metal housing have a same polarity and are integrated by laser welding to realize a more reliable sealing of the battery housing. A cap is arranged at and protruded from an outer side of the cover plate. An insulating member is arranged between the cover plate and the cap to prevent a short between the cover plate and the cap. One of the cathode and the anode is electrically connected to the metal housing, and another of the cathode and the anode is electrically connected to the cap.

### CROSS-REFERENCE TO RELATED APPLICATION

The present disclosure claims foreign priority of Chinese Patent Applications No. 201910835204.X, field on Sep. 5, 2019 in the State Intellectual Property Office of China, the entire contents of which are hereby incorporated by reference.

### TECHNICAL FIELD

The present disclosure relates to the field of button batteries, and in particular to a button battery improving a radial space utilization.

### BACKGROUND

At present, housings of button batteries on the market are not integrated designs, and a technical problem of poor sealing reliability exists. For example, a button battery disclosed in a Chinese application No. 201920094848.3 includes a cathode housing, an anode housing, and a seal body configured to seal the cathode housing and the anode housing. An R-corner sealing technology of the housing is performed, such that the seal body is compressed with an interference fit to achieve the sealing function between the cathode housing and the anode housing. However, a measurement of the R-angle in the prior art is not accurate, such that a good sealing capability of the battery housing and a quality qualification cannot completely guaranteed. Moreover, in a circumferential direction of the battery, an outer ring of the battery is the cathode housing, and an inner ring is the anode housing. The seal body is not arranged between the cathode housing and the anode housing. This multilayer structure takes up too much space in a radial direction of the battery, and a radial space cannot be fully utilized.

### SUMMARY OF THE DISCLOSURE

The present disclosure provides a button battery, including a metal housing, a cell arranged in the metal housing, and a cover plate arranged on the metal housing. The cell includes a cathode and an anode. The cover plate and the metal housing have a same polarity. A cap is arranged at and protruded from an outer surface of the cover plate. An insulating member is arranged between the cover plate and the cap, such that the cover plate and the cap may not be short-circuited. One of the cathode and the anode is electrically connected to the metal housing, and the other of the cathode and the anode is electrically connected to the cap.

### BRIEF DESCRIPTION OF THE DRAWINGS

To further illustrate technical solutions of embodiments of the present disclosure, drawings needed for description of the embodiments will be briefly introduced. Obviously, the following drawings are only some embodiments of the present disclosure. To any one of skill in the art, other drawings may be obtained without any creative work based on the following drawings.

FIG. 1 is a perspective view of a button battery improving a utilization rate of a radial space according to an embodiment of the present disclosure.

FIG. 2 is an exploded view of a button battery improving a utilization rate of a radial space according to an embodiment of the present disclosure.

FIG. 3 is a front view of a button battery improving a utilization rate of a radial space according to an embodiment of the present disclosure.

FIG. 4 is a cross-sectional view at A-A in FIG. 3.

FIG. 5 is a partially enlarged view at Position I in FIG. 4.

FIG. 6 is an exploded schematic view of a stacked cell structure according to an embodiment of the present disclosure.

FIG. 7 is a first structural schematic view of a wound-type cell according to an embodiment of the present disclosure.

FIG. 8 is a second structural schematic view of a wound-type cell according to an embodiment of the present disclosure.

FIG. 9 is a schematic view of cathode and anode tabs arranged at an end of an end surface of a cell according to an embodiment of the present disclosure.

FIG. 10 is a schematic view of cathode and anode tabs arranged at a middle of an end surface of a cell according to an embodiment of the present disclosure.

FIG. 11 is a perspective view of a cover howl arranged with a safety vent according to an embodiment of the present disclosure.

FIG. 12 is a perspective view of a cover plate arranged with a safety vent according to an embodiment of the present disclosure.

FIG. 13 is a perspective view of a metal housing arranged with a safety vent on a bottom according to an embodiment of the present disclosure.

### DETAILED DESCRIPTION

In order to make the objectives, technical solutions, and advantages of embodiments in the present disclosure clearer, the technical solutions in the embodiments of the present disclosure will be described clearly and completely with reference to the accompanying drawings. Obviously, the described embodiments are only some embodiments of the present disclosure. To any one of skill in the art, other embodiments may be obtained without any creative work and should be within the scope of the present disclosure.

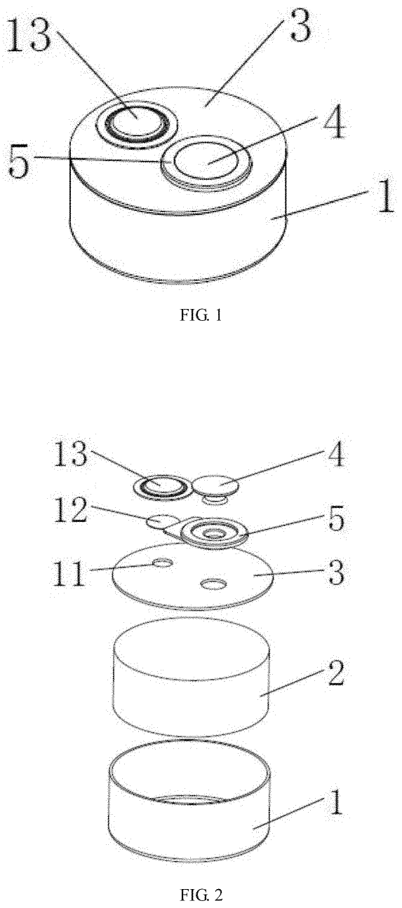

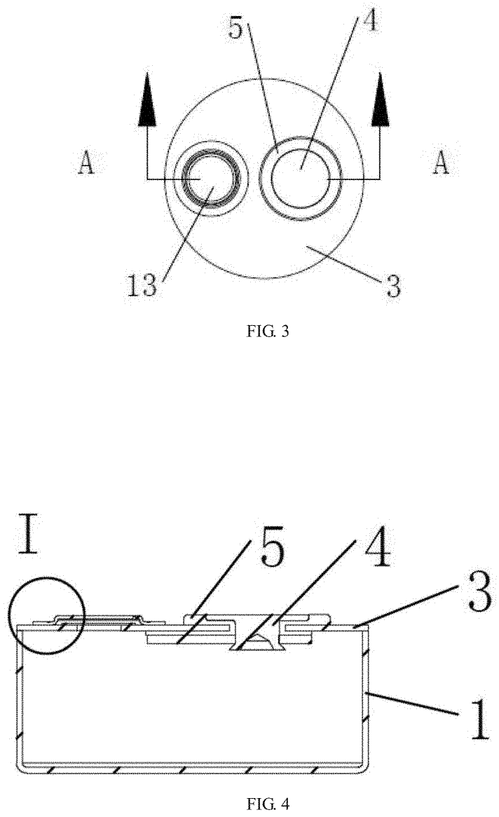

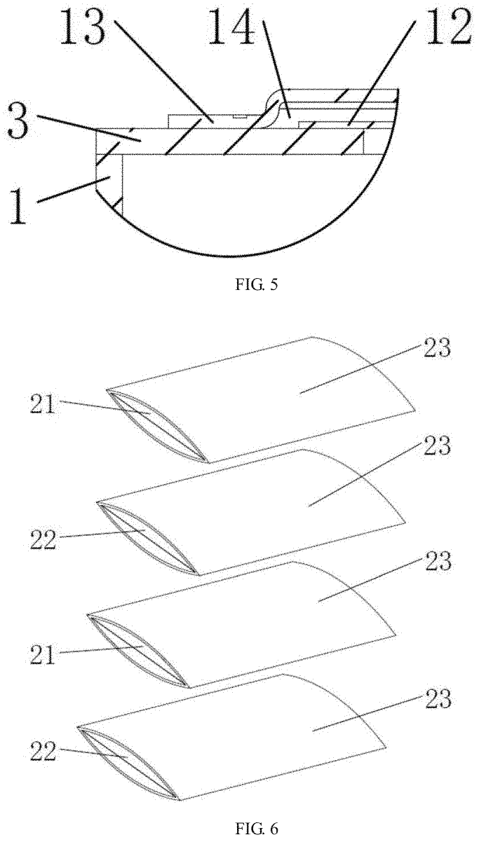

As shown in FIG. 1 to FIG. 5, the present disclosure provides a button battery improving a utilization rate of a radial space. The button battery includes a metal housing 1. The metal housing 1 may have a substantially cylindrical shape with an open upper end. A ratio of a diameter to a height of the metal housing 1 may be greater than 1, The metal housing 1 may be stamped from a nickel-plated deep-drawn metal sheet as a raw material. The metal housing 1 is arranged with a cell 2 including a cathode 21 and an anode 22. The metal housing 1 is also arranged with a cover plate 3. The cover plate 3 is a substantially circular sheet, disposed at the open upper end of the metal housing 1 and welded with the metal housing 1 as a whole. The cover plate 3 and the metal housing 1 may be made of a same material, such that a good sealing after welding is ensured and a leakage of the internal electrolyte is limited. The cover plate 3 may have a same polarity as the metal housing 1. A cap 4 is arranged at and protruded from an outer side of the cover plate 3. A protruding end of the cap 4 may have a substantially cylindrical shape. An insulating member 5 is arranged between the cover plate 3 and the cap 4, such that the cover plate 3 and the cap 4 may not be short-circuited. The insulating member 5 is arranged through an extrusion or an injection molding to realize a sealing between the cover plate 3 and the cap 4. One of the cathode 21 and the anode 22 is electrically connected to the metal housing 1, and another is electrically connected to the cap 4. The cover plate 3 is defined with an injection hole 11 penetrating into the metal housing 1. A safety vent 15 capable of communicating with the injection hole 11 may be arranged on the cover plate 3, such that an electrolyte is injected into the button battery through the safety vent 15. The cover plate 3 may also be arranged with a film 12 configured to seal the injection hole 11, such that the button battery may not leak the electrolyte during an automatic production operation. The electrolyte may be a lithium ion electrolyte with a charging function. A cover bowl 13 is arranged on the cover plate 3 at a same position as the film 12. The cover bowl 13 may be welded to the cover plate 3 through a laser welding, An air layer 14 is defined between the cover bowl 13 and the film 12. When a volume of a gas inside the cell 2 is excessively expanded, the gas may break through the film 12 and communicate with the air layer 14. The air layer 14 is configured to relieve a pressure of the gas inside the button battery, and reduce a risk of an expansion and an explosion of the button battery.

In some embodiments, the safety vent 15 may be a curved scoring with a circular angle in a range of 30°-360° and with a thickness in a range of 0.02-0.06 mm.

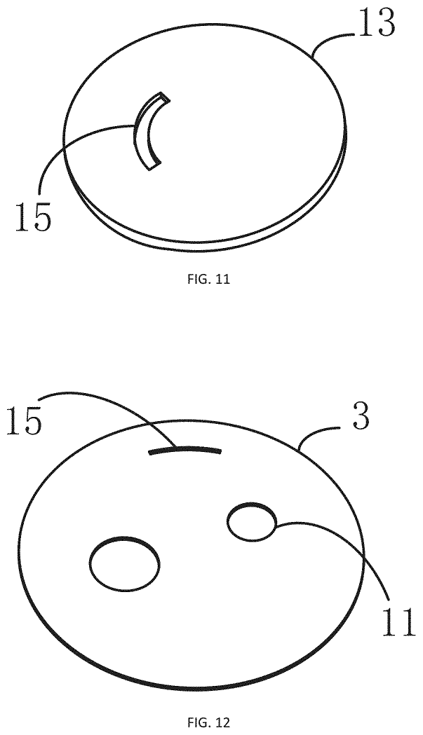

In some embodiments, as shown in FIG. 11, the safety vent 15 may be arranged at an inner surface of the cover bowl 13.

In some embodiments, as shown in FIG. 12, the safety vent 15 may be arranged at an inner surface of the cover plate 3.

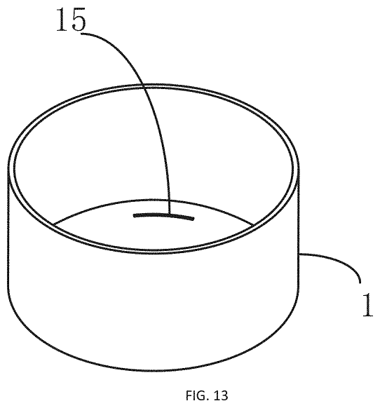

In some embodiments, as shown in FIG. 13, the safety vent 15 may be arranged at an inner surface of a bottom of the metal housing 1.

In some embodiments, the safety vent 15 may be arranged at an outer surface of the cover bowl 13, the cover plate 3, or the bottom of the metal housing 1. Several safety vents 15 may be arranged at one or more surfaces of the cover bowl 13, the cover plate 3, or the bottom of the metal housing 1, which is not limited herein.

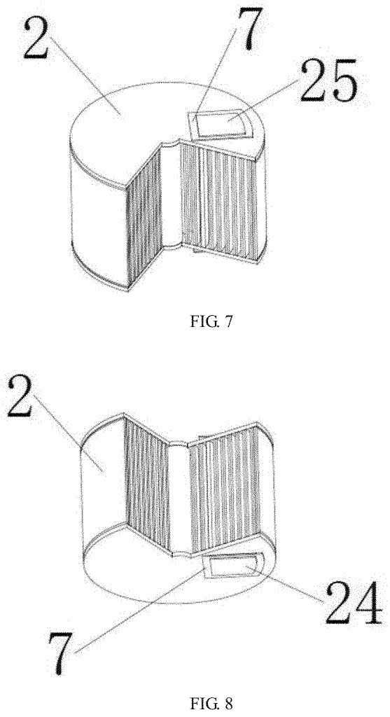

As shown in FIG. 6, the cell 2 may have a stacked structure in which the cathode 21, a separator 23, and the anode 22 are continuously stacked in a sequential order. The cathode 21, the separator 23, and the anode 22 may be square or round. The cathode 21 may be an aluminum sheet, and the anode 22 may be a nickel sheet or a copper sheet. The anode 22 has a function of embedding and removing lithium ions. The separator 23 is a porous plastic sheet with electrical insulation properties but capable of conducting ions. The separator 23 is made into a bag type. One of the cathode 21 and the anode 22 is wrapped in the separator 23, A plurality of the cathodes 21 are connected in parallel to form a positive current collector by welding. A plurality of the anodes 22 are connected in parallel to form a negative current collector by welding.

As shown in FIG. 7 and FIG. 8, the cell 2 may also have a winding structure formed by superimposing and winding the cathode 21, the separator 23, and the anode 22. A cathode tab 24 is led out from an end surface of the winding structure. An anode tab 25 is led out from another end surface of the winding structure. The cathode tab 24 and the anode tab 25 are respectively attached to each end surface of the winding structure through an insulating film 7. The cathode tab 24 is electrically connected to the cathode 21. The anode tab 25 is electrically connected to the anode 22. The cathode tab 24 and the anode tab 25 may be both designed with a flat sheet. The flat sheet may have a substantially circular, square or polygonal shape. The cathode tab 24 and the anode tab 25 may be both made of a metal foil having a good conductive property with a thickness of 5 micrometers to 100 micrometers. The insulating film 7 may be a sheet-shaped plastic adhesive film covering a side surface of the cathode tab 24 and the anode tab 25, and adhered to each end surface of the cell 2.

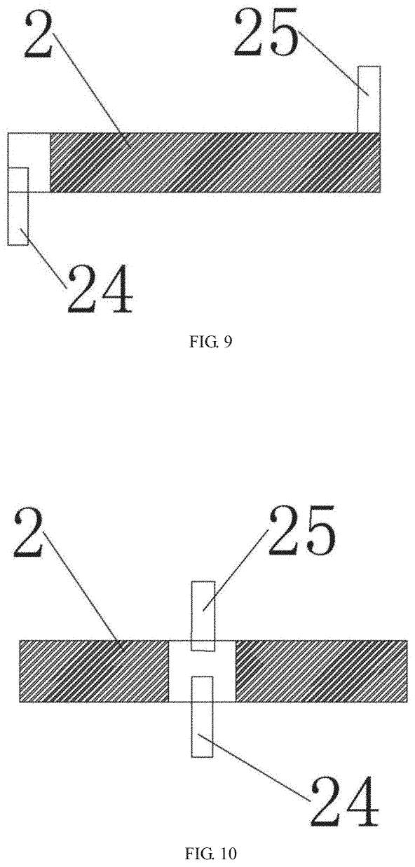

As shown in FIG. 9 and FIG. 10, the cathode tab 24 and the anode tab 25 are respectively disposed at a middle of each end surface of the cell 2, or respectively disposed at a tail of each end surface of the cell 2. The cathode tab 24 and the anode tab 25 disposed at the middle of each end surface of the cell 2 are capable of being bent with an angle of 90° toward a direction of the tail of an end surface of the cell 2 and attaching to a corresponding end surface. The cathode tab 24 and the anode tab 25 disposed at the tail of an end surface of the cell 2 are capable of being bent with an angle of 90° toward a direction of the middle of an end surface of the cell 2 and attaching to a corresponding end surface.

In summary, the present disclosure includes a metal housing 1, a cell 2 arranged in the metal housing 1, and a cover plate 3 arranged on the metal housing 1. The cell 2 includes a cathode 21 and an anode 22. The cover plate 3 and the metal housing 1 have a same polarity and are integrated by laser welding to realize a more reliable sealing of the battery housing. A cap 4 is arranged at and protruded from an outer side of the cover plate 3. An insulating member 5 is arranged along an outer edge of the cap 4 on the cover plate 3, such that the cover plate 3 and the cap 4 may not be short-circuited. One of the cathode 21 and the anode 22 is electrically connected to the metal housing 1 or the cover plate 3, and another of the cathode 21 and the anode 22 is electrically connected to the cap 4. The cell 2 is only separated from an outside by a single-layer metal housing, thereby improving the utilization rate of the radial space of the battery. The technology of the button battery is simpler, such that needs of a folly automated battery production are satisfied, a battery production efficiency is improved, and a yield is well guaranteed.

The above description is for the purpose of illustrating implementations of the present disclosure, but not to limit the scope of the present disclosure. Any equivalent structural or process transformation performed based on the drawings and the specification of the present disclosure, applied directly and indirectly in other related art, should be within the scope of the present disclosure.

What is claimed is:

1. A button battery, comprising:
a metal housing (1);
a cell (2) arranged in the metal housing (1); and
a cover plate (3) arranged on the metal housing (1);
wherein the cell (2) comprises a cathode (21) and an anode (22); the cover plate (3) and the metal housing (1) have a same polarity; a cap (4) is arranged at and protruded from an outer surface of the cover plate (3); an insulating member (5) is arranged between the cap (4) and the cover plate (3), such that the cover plate (3) and the cap (4) are not short-circuited; one of the cathode (21) and the anode (22) is electrically connected to the metal housing (1), and the other one of the cathode (21) and the anode (22) is electrically connected to the cap (4).

2. The button battery according to claim 1, wherein an injection hole (11) is defined on the cover plate (3) and communicated with an inner space of the metal housing (1).

3. The button battery according to claim 2, wherein a safety vent (15) is arranged on the cover plate (3) and communicated with the injection hole (11).

4. The button battery according to claim 3, wherein the safety vent (15) is a curved scoring with a circular angle in a range of about 30° to about 360° and with a thickness in a range of about 0.02 mm to about 0.06 mm.

5. The button battery according to claim 2, wherein a film (12) is located on the outer surface of the cover plate (3) for sealing the injection hole (11).

6. The button battery according to claim 5, wherein a cover bowl (13) is arranged on the outer surface of the cover plate (3) so that the film (12) is between the cover bowl (13) and the cover plate (3), and an air layer (14) is defined between the cover bowl (13) and the film (12); when a volume of a gas inside the metal housing (1) is excessively expanded, the gas breaks through the film (12) and the metal housing (1) is communicated with the air layer (14).

7. The button battery according to claim 6, wherein the safety vent (15) is arranged at an inner surface of the cover howl (13), or at an inner surface of the cover plate (3), or at an inner surface of a bottom of the metal housing (1).

8. The button battery according to claim 1, wherein the metal housing (1) has a substantially cylindrical shape with an open end, and the cover plate (3) is disposed at the open end of the metal housing (1) and welded with the metal housing (1).

9. The button battery according to claim 8, wherein a ratio of a diameter of the metal housing (1) to a height of the metal housing (1) is greater than 1.

10. The button battery according to claim 1, wherein the cell (2) comprises a separator (23) configured as a bag; one of the cathode (21) and the anode (22) is wrapped in the separator (23); a plurality of the cathodes (21) are connected in parallel to form a positive current collector; a plurality of the anodes (22) are connected in parallel to form a negative current collector.

11. The button battery according to claim 10, wherein the separator (23) is a porous plastic sheet with electrical insulation properties and capable of conducting ions.

12. The button battery according to claim 10, wherein the cell (2) has a stacked structure in which the cathode (21), the separator (23), and the anode (22) are continuously stacked in a sequential order.

13. The button battery according to claim 10, wherein the cell (2) has a winding structure formed by superimposing and winding the cathode (21), the separator (23), and the anode 22.

14. The button battery according to claim 13, wherein a cathode tab (24) is led out from a first end surface of the winding structure, and an anode tab (25) is led out from a second end surface of the winding structure; the cathode tab (24) and the anode tab (25) are respectively attached to the first end surface or the second end surface of the winding structure correspondingly through an insulating film (7); the cathode tab (24) is electrically connected to the cathode (21), and the anode tab (25) is electrically connected to the anode (22).

15. The button battery according to claim 14, wherein the cathode tab (24) and the anode tab (25) are respectively disposed at a middle of the first end surface or the second end surface of the cell (2) correspondingly, or respectively disposed at a tail of the first end surface or the second end surface of the cell (2) correspondingly.

16. The button battery according to claim 15, wherein the cathode tab (24) and the anode tab (25) respectively disposed at the middle of the first end surface or the second end surface of the cell (2) correspondingly are capable of being bent with an angle of 90° toward a direction of the tail of an end surface of the cell (2) and attaching to a corresponding end surface; the cathode tab (24) and the anode tab (25) disposed at the tail of the first end surface or the second end surface of the cell (2) correspondingly are capable of being bent with an angle of 90° toward a direction of the middle of an end surface of the cell (2) and attaching to a corresponding end surface.
